(19) United States
(12) Patent Application Publication
(10) Pub. No.: US 2018/0329531 A1
(43) Pub. Date: Nov. 15, 2018

(54) GRATING STRUCTURE, DISPLAY APPARATUS HAVING THE SAME, AND FABRICATING METHOD THEREOF

(71) Applicant: BOE TECHNOLOGY GROUP CO., LTD., Beijing (CN)

(72) Inventor: Chunmiao Zhou, Beijing (CN)

(73) Assignee: BOE TECHNOLOGY GROUP CO., LTD., Beijing (CN)

(21) Appl. No.: 15/578,544

(22) PCT Filed: Jun. 30, 2017
(86) PCT No.: PCT/CN2017/091103

§ 371 Date: Nov. 30, 2017

(30) Foreign Application Priority Data
Sep. 30, 2016 (CN) 201610875249.6

(51) Int. Cl. G06F 3/044; G06F 3/041

(52) U.S. Cl. CPC G06F 3/044; G06F 2203/04103; G06F 3/0412

(57) ABSTRACT

The present application discloses a grating structure. The grating structure includes a transparent base substrate a first grating layer on the transparent base substrate and configured to direct light transmitted through a grating structure into a first view zone and a second view zone; and a first touch signal line layer on the transparent base substrate and including a plurality of first touch signal lines. The first grating layer includes a plurality of first light barriers respectively in a plurality of first light blocking regions and a plurality of first slits respectively in a plurality of first light transmissive regions. At least one of the plurality of first touch signal lines extends through one of the plurality of the first light blocking regions.

### CROSS-REFERENCE TO RELATED APPLICATION

This application claims priority to Chinese Patent Application No. 201610875249.6, filed Sep. 30, 2016, the contents of which are incorporated by reference in the entirety.

### TECHNICAL FIELD

The present invention relates to display technology, more particularly, to a grating structure, a display apparatus having the same, and a fabricating method thereof.

### BACKGROUND

Multi-view display apparatus or three-dimensional display apparatus have been developed as various types of display apparatuses, such as televisions, entertainment systems, gaming systems, mobile phones, and navigation systems.

### SUMMARY

In one aspect, the present invention provides a grating structure comprising a transparent base substrate; a first grating layer on the transparent base substrate and configured to direct light transmitted through a grating structure into a first view zone and a second view zone; and a first touch signal line layer on the transparent base substrate and comprising a plurality of first touch signal lines; wherein the first grating layer comprises a plurality of first light barriers respectively in a plurality of first light blocking regions and a plurality of first slits respectively in a plurality of first light transmissive regions; the plurality of first light barriers are substantially along a first direction, each of the plurality of first light barriers extending substantially along a second direction; the plurality of first slits are substantially along the first direction, each of the plurality of first slits extending substantially along the second direction; the plurality of first touch signal lines are substantially along the first direction, each of the plurality of first touch signal lines extending substantially along the second direction; and at least one of the plurality of first touch signal lines extends through one of the plurality of the first light blocking regions.

Optionally, at least one of the plurality of first touch signal lines is electrically connected to one of the plurality of first light barriers.

Optionally, at least one of the plurality of first touch signal lines is in contact with one of the plurality of first light barriers over an entire length where it extends through the one of the plurality of the first light blocking regions.

Optionally, the first grating layer and the first touch signal line layer are in a same layer and comprise a same material; and at least a portion of each of the plurality of first touch signal lines in the plurality of the first light blocking regions is integrated with one of the plurality of first light barriers.

Optionally, the grating structure further comprises a second touch signal line layer on the transparent base substrate and comprising a plurality of second touch signal lines; and an insulating layer between the second touch signal line layer and the first grating layer; wherein the plurality of second touch signal lines are substantially along the second direction, each of the plurality of second touch signal lines extending substantially along the first direction.

Optionally, the grating structure further comprises a second grating layer on the transparent base substrate and comprising a plurality of second light barriers respectively in a plurality of second light blocking regions and a plurality of second slits respectively in a plurality of second light transmissive regions; and at least one of the plurality of second touch signal lines extends through one of the plurality of the second light blocking regions.

Optionally, the insulating layer is on a side of the second grating layer distal to the transparent base substrate; and the first grating layer and the first touch signal line layer are on a side of the insulating layer distal to the second grating layer.

Optionally, at least one of the plurality of second touch signal lines is electrically connected to one of the plurality of second light barriers.

Optionally, at least one of the plurality of second touch signal lines is in contact with one of the plurality of second light barriers over an entire length where it extends through the one of the plurality of the second light blocking regions.

Optionally, the second grating layer and the second touch signal line layer are in a same layer and comprise a same material; and at least a portion of each of the plurality of second touch signal lines in the plurality of the second light blocking regions is integrated with one of the plurality of second light barriers.

Optionally, at least one of the plurality of first touch signal lines comprises a portion outside the plurality of the first light blocking regions.

Optionally, the first touch signal line layer further comprising a plurality of connecting wires electrically connecting the plurality of first touch signal lines to a touch driver circuit; wherein the plurality of connecting wires are outside the plurality of first light blocking regions.

Optionally, the plurality of first light barriers comprise a black ink comprising a conductive material; and the plurality of first touch signal lines comprise the conductive material.

Optionally, the plurality of first light barriers comprise a black nano-silver particle ink, and the plurality of first touch signal lines comprise nano-silver particles.

Optionally, the transparent base substrate comprises polyethylene glycol terephthalate, or polyethylene naphthalate, or a combination thereof.

In another aspect, the present invention provides a display apparatus comprising the grating structure described herein; a display panel; and a touch control circuit electrically connected to the plurality of first touch signal lines; wherein the grating structure is on a light emitting side of the display panel.

In another aspect, the present invention provides a method of fabricating a grating structure, comprising forming a first grating layer on a transparent base substrate; and forming a first touch signal line layer on the transparent base substrate; wherein forming the first grating layer comprises forming a plurality of first light barriers in a plurality of first light blocking regions; the plurality of first light barriers being formed to be arranged substantially along a first direction, each of the plurality of first light barriers being formed to extend substantially along a second direction; forming the first touch signal line layer comprises forming a plurality of first touch signal lines arranged substantially along the first direction, each of the plurality of first touch signal lines being formed to extend substantially along the second direction and extend through one of the plurality of the first light blocking regions.

Optionally, the first rating layer and the first touch signal line layer are funned in a single process using a same material.

Optionally, the method comprises forming a polymer layer on the transparent base substrate; forming an activated surface pattern on the polymer layer corresponding to a pattern of the first grating layer and the first touch signal line layer; coating a black ink comprising a conductive material on the polymer layer, thereby thrilling the first grating layer and the first touch signal line layer.

Optionally, the polymer layer comprises a fluoropolymer; forming the activated surface pattern comprises exposing the polymer layer to UV irradiation using a mask plate having a pattern corresponding to the pattern of the first grating layer and the first touch signal line layer; and exposed portions of the polymer layer are activated for adhering the black ink comprising the conductive material.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a grating structure in a display apparatus in some embodiments according to the present disclosure.

FIG. 2 is a schematic diagram illustrating the structure of a first grating layer in some embodiments according to the present disclosure.

FIG. 3 is a schematic diagram illustrating the structure of a grating structure in a display apparatus in some embodiments according to the present disclosure.

FIG. 4 is a cross-section view along A-A′ line in the grating structure of FIG. 3.

FIG. 5 is a cross-section view along B-B′ line in the grating structure of FIG. 3.

FIG. 6 is a schematic diagram illustrating the structure of a grating structure in a display apparatus in some embodiments according to the present disclosure.

FIG. 7 is a schematic diagram illustrating the structure of a second grating layer in some embodiments according to the present disclosure.

FIG. 8 is a flow chart illustrating a method of fabricating a grating structure in some embodiments according to the present disclosure.

FIGS. 9A to 9C illustrate a process of fabricating a grating structure in some embodiments according to the present disclosure.

FIGS. 10A to 10D illustrate a process of fabricating a grating structure in some embodiments according to the present disclosure.

FIGS. 11A to 11D illustrate a process of fabricating a grating structure in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

In conventional display apparatus, to achieve touch control function, typically a touch panel is attached to the display panel. To achieve multi-view display or three-dimensional display, an additional grating structure has to be attached to the display panel. Thus, the conventional touch control multi-view or three-dimensional display apparatus is not only bulky, but involves a highly complicated fabricating process and high manufacturing costs.

Accordingly, the present disclosure provides, inter alia, a grating structure, a display apparatus having the same, and a fabricating method thereof that substantially obviate one or more of the problems due to limitations and disadvantages of the related art. In one aspect, the present disclosure provides a grating structure. In some embodiments, the grating structure includes a transparent base substrate; a first grating layer on the transparent base substrate and configured to direct light transmitted through a grating structure into a first view zone and a second view zone; and a first touch signal line layer on the transparent base substrate and including a plurality of first touch signal lines. The grating structure has a plurality of first light blocking regions, the first grating layer includes a plurality of first light barriers respectively in the plurality of first light blocking regions of the grating structure. The grating structure further includes a plurality of first light transmissive regions spaced apart by the plurality of first light blocking regions. The first grating layer includes a plurality of first slits respectively in the plurality of first light transmissive regions. Optionally, the plurality of first light barriers are electrically conductive. Optionally, the first grating layer is a parallax barrier grating layer.

In some embodiments, the plurality of first light barriers are arranged substantially along a first direction, each of the plurality of first light barriers extending substantially along a second direction. Optionally, the plurality of first slits are arranged substantially along the first direction, each of the plurality of first slits extending substantially along the second direction. Optionally, the plurality of first touch signal lines are arranged substantially along the first direction, each of the plurality of first touch signal lines extending substantially along the second direction. Optionally, each of the plurality of first touch signal lines extends through one of the plurality of the first light blocking regions. Optionally, at least one (e.g., each) of the plurality of first touch signal lines extends through an entire length of one of the plurality of the first light blocking regions.

The present grating structure includes a first region and a second region outside the first region. The first region is a region defined by the combination of the plurality of first light barriers and the plurality of first slits, i.e., a “grating region.” The first region consists essentially of the regions corresponding to the plurality of first light barriers and the plurality of first slits. Optionally, in the first region, a projection of at least one (e.g., each) of the plurality of first touch signal lines on the transparent base substrate is substantially covered by that of one of the plurality of first light barriers. For example, in the first region, the projection of at least one (e.g., each) of the plurality of first touch signal lines on the transparent base substrate is substantially non-overlapping with projections of the plurality of first slits on the transparent base substrate.

By having each of the plurality of first touch signal lines extending through one of the plurality of the first light blocking regions, the presence of the plurality of first touch signal lines in the grating structure do not interfere with light transmission through the first grating layer in the plurality of first slits. Thus, the present grating structure is a dual-function structure functioning as both a grating layer and a touch substrate. By having this integrated design, the present grating structure obviates the needs of having separate touch substrate and grating structure in a display apparatus, significantly simplifying the fabricating process and achieving a highly miniaturized display apparatus.

In some embodiments, the plurality of first touch signal lines is electrically connected to one of the plurality of first light barriers. Optionally, at least one (e.g., each) of the plurality of first touch signal lines is in contact with one of the plurality of first light barriers over an entire length wherein it extends through the one of the plurality of the first light blocking regions. Optionally, the plurality of first touch signal lines and the plurality of first light barriers are in a same layer and made of a same material (e.g., formed in a single process). Optionally, a portion of at least one (e.g., each) of the plurality of first touch signal lines in the plurality of the first light blocking regions is integrated with one of the plurality of first light barriers. By having the plurality of first touch signal lines and the plurality of first light barriers formed in a single process, the fabricating process can be greatly simplified.

As used herein, the term “same layer” refers to the relationship between the layers simultaneously formed in the same step. In one example, the plurality of first touch signal lines and the plurality of first light barriers are in a same layer when they are formed as a result of one or more steps of a same patterning process performed in a same layer of material. In another example, the plurality of first touch signal lines and the plurality of first light barriers can be formed in a same layer by simultaneously performing the step of forming the plurality of first touch signal lines and the step of forming the plurality of first light barriers. The term “same layer” does not always mean that the thickness of the layer or the height of the layer in a cross-sectional view is the same.

Optionally, the plurality of first touch signal lines are separated from the plurality of first light barriers. Optionally, the first grating layer and the first touch signal line layer are in two separate layers. Optionally, the first grating layer and the first touch signal line layer are formed separately.

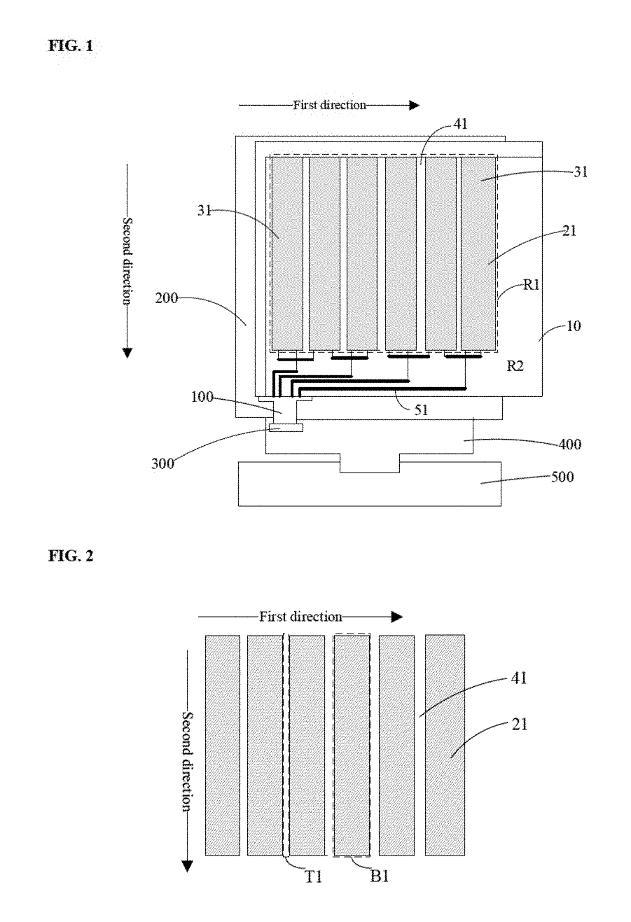

FIG. 1 is a schematic diagram illustrating the structure of a grating structure in a display apparatus in some embodiments according to the present disclosure. Referring to FIG. 1, the grating structure in some embodiments includes a transparent base substrate 10; a first grating layer on the transparent base substrate 10 and including a plurality of first light barriers 21 in a plurality of first light blocking regions of the grating structure and a plurality of first slits 41 respectively in a plurality of first light transmissive regions of the grating structure; and a first touch signal line layer on the transparent base substrate 10 and including a plurality of first touch signal lines 31. At least one (e.g., each) of the plurality of first light blocking regions of the grating structure is a region corresponding to one of the plurality of first light barriers 21. The first grating layer is configured to direct light transmitted through the grating structure into a first view zone and a second view zone.

In some embodiments, the grating structure includes a plurality of grating units. Each of the grating units of the grating structure includes at least one light blocking region and at least one light transmissive region abutting the at least one light blocking region. FIG. 2 is a schematic diagram illustrating the structure of a first grating layer in some embodiments according to the present disclosure. Referring to FIG. 2, the grating structure in some embodiments has a plurality of first light blocking regions B1, the first grating layer includes a plurality of first light barriers 21 respectively in the plurality of first light blocking regions B1 of the grating structure. The grating structure further includes a plurality of first light transmissive regions T1 spaced apart by the plurality of first light blocking regions B1. The first grating layer includes a plurality of first slits 41 respectively in the plurality of first light transmissive regions T1. Optionally, the plurality of first light barriers 21 are electrically conductive. Optionally, the plurality of first light barriers 21 are spaced apart from each other by a plurality of first light transmissive regions T1.

As shown in FIG. 1, the plurality of first light barriers 21 are spaced apart from each other and are arranged substantially along a first direction. Each of the plurality of first light barriers 21 extends substantially along a second direction. The plurality of first touch signal lines 31 are arranged substantially along the first direction. Each of the plurality of first touch signal lines 31 extends substantially along the second direction. Referring to FIG. 1 and FIG. 2, each of the plurality first touch signal lines 31 extends through one of the plurality of the first light blocking regions B1. Optionally, at least one (e.g., each) of the plurality of first touch signal lines 31 extends through an entire length of the one of the plurality of the first light blocking regions B1. Referring to FIG. 1 and FIG. 2, the plurality of first slits 41 are spaced apart from each other and are arranged substantially along the first direction. Each of the plurality of first slits 41 extends substantially along the second direction.

Referring to FIG. 1 and FIG. 2, the grating structure includes a first region R1 (the region encircled by the dotted lines) and a second region R2 outside the first region R1. The first region R1 is a region defined by the combination of the plurality of first light barriers 21 and the plurality of first slits 41. The first region R1 consists essentially of the regions corresponding to the plurality of first light barriers 21 and the plurality first slits 41. As shown in FIG. 1, in the first region R1, a projection of at least one (e.g., each) of the plurality of first touch signal lines 31 on the transparent base substrate 10 is substantially covered by that of one of the plurality of first light barriers 21. For example, in the first region R1, the projection of at least one (e.g., each) of the plurality of first touch signal lines 31 on the transparent base substrate 10 is substantially non-overlapping with projections of the plurality of first slits 41 on the transparent base substrate 10.

In some embodiments, the plurality of first touch signal lines 31 is electrically connected to one of the plurality of first light barriers 21. Optionally, at least one (e.g., each) of the plurality of first touch signal lines 31 is in contact with one of the plurality of first light barriers 21 over an entire length where it extends through the one of the plurality of the first light blocking regions B1. Optionally, the plurality of first touch signal lines 31 and the plurality of first light barriers 21 are in a same layer and made of a same material (e.g., formed in a single process). Optionally, a portion of at least one (e.g., each) of the plurality of first touch signal lines 31 in the plurality of the first light blocking regions B1 is integrated with one of the plurality of first light barriers 21. By having the plurality of first touch signal lines 31 and the plurality of first light barriers 21 formed in a single process, the fabricating process can be greatly simplified.

In some embodiments, in the first region R1, a projection of each of the plurality of first light barriers 21 covers those of multiple adjacent first touch signal lines of the plurality of first touch signal lines 31. As shown in FIG. 1, in the first region R1, a projection of each of the plurality of first light barriers 21 covers those of two adjacent first touch signal lines of the plurality of first touch signal lines 31. Optionally, multiple adjacent first touch signal lines of the plurality of first touch signal lines 31 extend through each of the plurality of the first light blocking regions B1, e.g., extend through an entire length of each of the plurality of the first light blocking regions B1. As shown in FIG. 1, two adjacent first touch signal lines of the plurality first touch signal lines 31 extend through each of the plurality of the first light blocking regions B1, e.g., extend through an entire length of each of the plurality of the first light blocking regions B1. A width of each of the plurality of the first light blocking regions B1 or a width of each of each of the plurality of first light barriers 21 determines an aperture ratio of the grating structure. A density of the plurality of first touch signal lines 31 determines touch control accuracy Accordingly, these parameters may be determined based on a desired aperture ratio or desired touch control accuracy.

By having each of the plurality first touch signal lines 31 extending through one of the plurality of the first light blocking regions B1, the presence of the plurality of first touch signal lines 31 in the grating structure do not interfere with light transmission through the first grating layer in the plurality of first slits 41.

In some embodiments, the plurality of first light barriers 21 are made of a black ink including a conductive material, and the plurality of first touch signal lines 31 are made of a same conductive material. Various appropriate conductive material may be used for making the plurality of first light barriers 21 and the plurality of first touch signal lines 31. Examples of conductive materials include nano-metal particles (e.g., nano-silver particles), carbon particle materials, nano-tubes, graphene, and so on. Optionally, the plurality of first touch signal lines 31 are made of nano-silver particles, and the plurality of first light barriers 21 are made of a black nano-silver particle ink. Accordingly, the plurality of first light barriers 21 and the plurality of first touch signal lines 31 can be made in a single process. A portion of at least one (e.g., each) of the plurality of first touch signal lines 31 in the plurality of the first light blocking regions B1 is integrated with one of the plurality of first light barriers 21. For example, the portion of at least one (e.g., each) of the plurality of first touch signal lines 31 in the first region is integrated with one of the plurality of first light barriers 21.

Various appropriate transparent materials may be used for making the transparent base substrate 10. Optionally, the transparent base substrate 10 is made of polyethylene glycol terephthalate, or polyethylene naphthalate, or a combination thereof.

In some embodiments, the grating structure is a parallax barrier grating structure having a plurality of barriers (i.e., the plurality of first light barriers 21) and a plurality of slits (i.e., the plurality of first slits 41). The touch signal lines are integrated into the barriers of the grating structure. As shown in FIG. 1, in a display apparatus having the present grating structure, the plurality of first touch signal lines 31 are respectively connected to a touch driver circuit in a touch driver chip 100, which is disposed in a printed circuit board 200 and electrically connected to a display circuit board 400 through a connector 300. The display circuit board 400 is electrically connected to a mother board 500 of the display apparatus. In a display apparatus having the present grating structure, the mother board 500 sends control signals to control the touch driver circuit in the touch driver chip 100 to send touch control signals or receive touch sensing signals.

Referring to FIG. 1 and FIG. 2, at least one (e.g., each) of the plurality of first touch signal lines 31 in some embodiments includes a portion outside the plurality of the first light blocking regions B1 or outside the first region R1 (e.g., in the second region R2). In FIG. 1, the touch sensing area is greater than the grating area (e.g., an area in the first region R1). Optionally, the first touch signal line layer in some embodiments further includes a plurality of first connecting wires 51 electrically connecting the plurality of first touch signal lines 31 to the touch driver circuit in the touch driver chip 100. The plurality of first connecting wires 51 are disposed outside the plurality of the first light blocking regions B1 or outside the first region R1 (e.g., in the second region R2).

In some embodiments, the display apparatus further includes a touch panel attached to the grating structure to enhance touch sensitivity. In some embodiments, the touch panel includes a plurality of second touch signal lines arranged substantially along the second direction, each of the plurality of second touch signal lines extending substantially along the first direction. The plurality of second touch signal lines in the touch panel and the plurality of first touch signal lines 31 in the grating structure cross over each other and cooperatively achieve touch detection.

In some embodiments, the grating structure further includes a second touch signal line layer on the transparent base substrate and including a plurality of second touch signal lines. FIG. 3 is a schematic diagram illustrating the structure of a grating structure in a display apparatus in some embodiments according to the present disclosure. Referring to FIG. 3, the grating structure in some embodiments further includes second touch signal line layer on the transparent base substrate 10 and including a plurality of second touch signal lines 32. Optionally, the plurality of second touch signal lines 32 are arranged substantially along the second direction. Optionally, each of the plurality of second touch signal lines 32 extends substantially along the first direction.

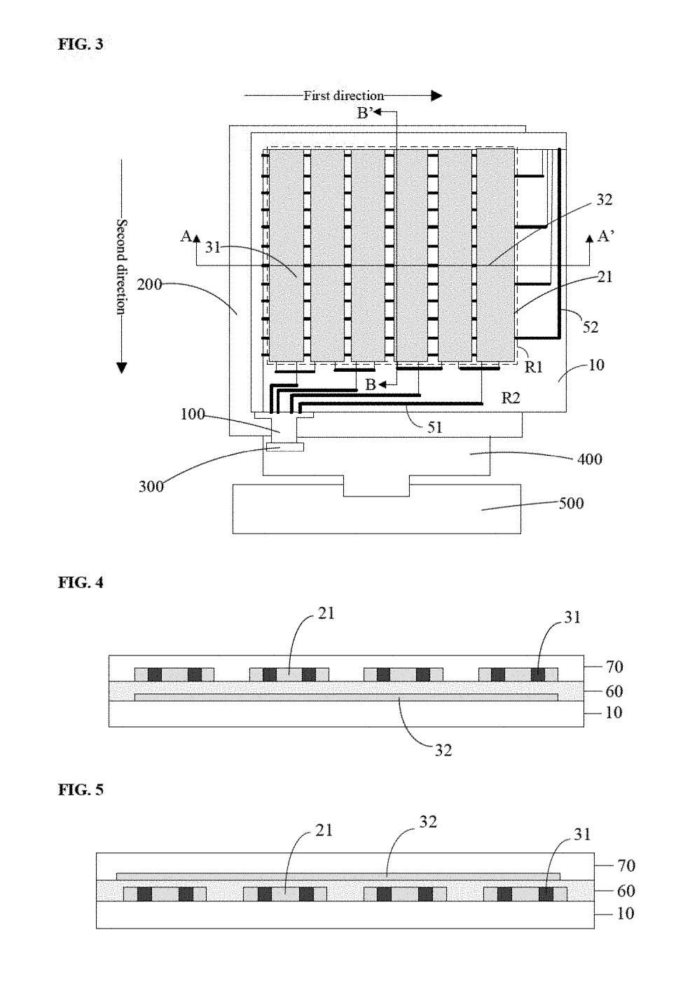

In some embodiments, the grating structure further includes an insulating layer between the second touch signal line layer and the first grating layer. FIG. 4 is a cross-section view along A-A′ line in the grating structure of FIG. 3. Referring to FIG. 4, the grating structure in some embodiments includes a transparent base substrate 10, a second touch signal line layer including a plurality of second touch signal lines 32 on the transparent base substrate 10, an insulating layer 60 on a side of the second touch signal line layer distal to the transparent base substrate 10, a first grating layer including a plurality of first light barriers 21 and a first touch signal line layer including a plurality of first touch signal lines 31 on a side of the insulating layer 60 distal to the second touch signal line layer. Optionally, the grating structure further includes a passivation layer 70 on a side of the first grating layer and the first touch signal line layer distal to the insulating layer 60.

FIG. 5 is a cross-section view along B-B′ line in the grating structure of FIG. 3. Referring to FIG. 5, the grating structure in some embodiments includes a transparent base substrate 10, a first grating layer including a plurality of first light barriers 21 and a first touch signal line layer including a plurality of first touch signal lines 31 on the transparent base substrate 10, an insulating layer 60 on a side of the first grating layer and the first touch signal line layer distal to the transparent base substrate 10, a second touch signal line layer including a plurality of second touch signal lines 32 on a side of the insulating layer 60 distal to the first grating layer and the first touch signal line layer. Optionally, the grating structure further includes a passivation layer 70 on a side of the second touch signal line layer distal to the insulating layer 60.

Various appropriate conductive material may be used for making the plurality of second touch signal lines 32. Examples of conductive materials include nano-metal particles (e.g., nano-silver particles), carbon particle materials, nano-tubes, graphene, and so on. In some embodiments, the plurality of first light barriers 21 are made of a black ink including a conductive material, the plurality of first touch signal lines 31 and the plurality of second touch signal lines 32 are made of a same conductive material. Optionally, the plurality of first touch signal lines 31 and the plurality of second touch signal lines 32 are made of nano-silver particles, and the plurality of first light barriers 21 are made of a black nano-silver particle ink. Optionally, the plurality of first light barriers 21 and the plurality of first touch signal lines 31 can be made in a single process. A portion of at least one (e.g., each) of the plurality of first touch signal lines 31 in the plurality of the first light blocking regions B1 is integrated with one of the plurality of first light barriers 21. For example, the portion of at least one (e.g., each) of the plurality of first touch signal lines 31 in the first region R1 is integrated with one of the plurality of first light barriers 21.

Various appropriate transparent materials may be used for making the transparent base substrate 10. Optionally, the transparent base substrate 10 is made of polyethylene glycol terephthalate, or polyethylene naphthalate, or a combination thereof.

Various appropriate insulating materials may be used for making the insulating layer 60. Optionally, the insulating layer 60 is made of an optical clear resin.

In some embodiments, the grating structure is a parallax barrier grating structure having a plurality of barriers (i.e., the plurality of first light barriers 21) and a plurality of slits (i.e., the plurality of first slits 41). The touch signal lines are integrated into the grating structure. For example, the plurality of first touch signal lines 31 and the plurality of second touch signal lines 32 crossing over each other are used for detecting touch. Optionally, the touch detection is a mutual capacitive type touch detection. Optionally, the plurality of first touch signal lines 31 are touch scanning signal lines and the plurality of second touch signal lines 32 are touch sensing signal lines. Optionally, the plurality of first touch signal lines 31 are touch sensing signal lines and the plurality of second touch signal lines 32 are touch scanning signal lines.

As shown in FIG. 3, in a display apparatus having the present grating structure, the plurality of first touch signal lines 31 and the plurality of second touch signal lines 32 are respectively connected to a touch driver circuit in a touch driver chip 100, which is disposed in a printed circuit board 200 and electrically connected to a display circuit board 400 through a connector 300. The display circuit board 400 is electrically connected to a mother board 500 of the display apparatus. In a display apparatus having the present grating structure, the mother board 500 sends control signals to control the touch driver circuit in the touch driver chip 100 to send touch control signals or receive touch sensing signals.

Referring to FIG. 3 and FIG. 2, at least one (e.g., each) of the plurality of first touch signal lines 31 in some embodiments includes a portion outside the plurality of the first light blocking regions B1 or outside the first region R1 (e.g., in the second region R2), and at least one (e.g., each) of the plurality of second touch signal lines 32 in some embodiments includes a portion outside the plurality of the first light blocking regions B1 or outside the first region R1 (e.g., in the second region R2). In FIG. 3, the touch sensing area is greater than the grating area (e.g., an area in the first region R1).

Optionally, the first touch signal line layer in some embodiments further includes a plurality of first connecting wires 51 electrically connecting the plurality of first touch signal lines 31 to the touch driver circuit in the touch driver chip 100. Optionally, the second touch signal line layer in some embodiments further includes a plurality of second connecting wires 52 electrically connecting the plurality of second touch signal lines 32 to the touch driver circuit in the touch driver chip 100. The plurality of first connecting wires 51 and the plurality of second connecting wires 52 are disposed outside the plurality of the first light blocking regions B1 or outside the first region R1 (e.g., in the second region R2).

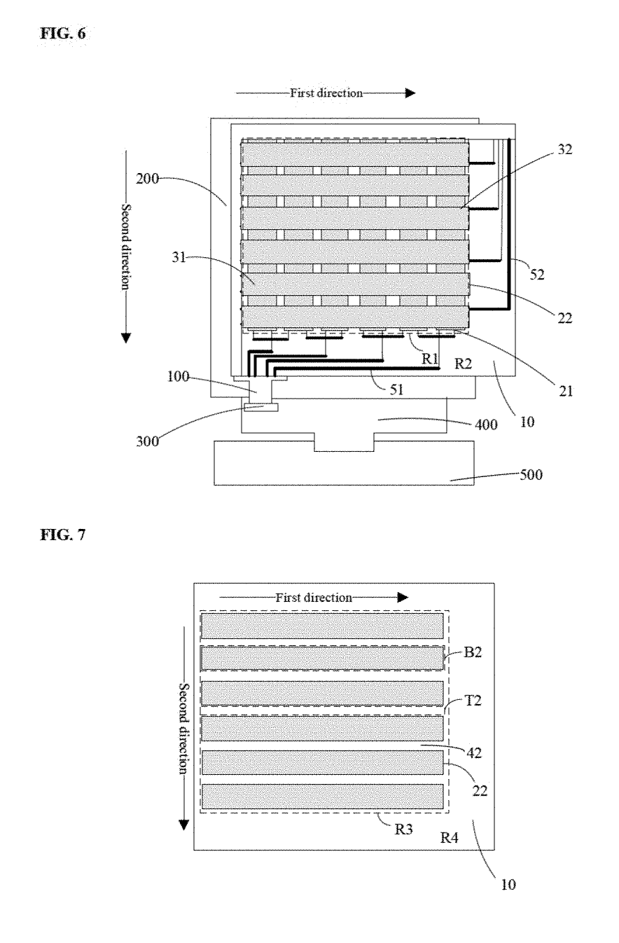

In some embodiments, the grating structure further includes a second grating layer. FIG. 6 is a schematic diagram illustrating the structure of a grating structure in a display apparatus in some embodiments according to the present disclosure. Referring to FIG. 6, the grating structure in some embodiments includes a transparent base substrate 10 a first grating layer on the transparent base substrate 10 and including a plurality of first light barriers 21 in a plurality of first light blocking regions of the grating structure; a first touch signal line layer on the transparent base substrate 10 and including a plurality of first touch signal lines 31. Moreover, the grating structure in FIG. 6 further includes a second grating layer on the transparent base substrate 10 and including a plurality of second light barriers 22 in a plurality of second light blocking regions of the grating structure; and a second touch signal line layer on the transparent base substrate 10 and including a plurality of second touch signal lines 32. Each of the plurality of first light blocking regions of the grating structure is a region corresponding to one of the plurality of first light barriers 21. The first grating layer is configured to direct light transmitted through the grating structure into a first view zone and a second view zone. Each of the plurality of second light blocking regions of the grating structure is a region corresponding to one of the plurality of second light barriers 22.

In some embodiments, the grating structure includes a plurality of grating units. Each of the grating units of the grating structure includes at least one light blocking region and at least one light transmissive region abutting the at least one light blocking region. FIG. 7 is a schematic diagram illustrating the structure of a second grating layer in some embodiments according to the present disclosure. Referring to FIG. 7, the grating structure in some embodiments has a plurality of second light blocking regions B2, the second grating layer includes a plurality of second light barriers 22 respectively in the plurality of second light blocking regions B2 of the grating structure. The grating structure further includes a plurality of second light transmissive regions T2 spaced apart by the plurality of second light blocking regions B2. The second grating layer includes a plurality of second slits 42 respectively in the plurality of second light transmissive regions T2. Optionally, the plurality of second light barriers 22 are electrically conductive. Optionally, the plurality of second light barriers 22 are spaced apart from each other by a plurality of second light transmissive regions T2.

As, shown in FIG. 6, the plurality of first light barriers 21 are spaced apart from each other and are arranged substantially along a first direction. Each of the plurality of first light barriers 21 extends substantially along a second direction. The plurality of first touch signal lines 31 are arranged substantially along the first direction. Each of the plurality of first touch signal, lines 31 extends substantially along the second direction. The plurality of second light barriers 22 are spaced apart from each other and are arranged substantially along the second direction. Each of the plurality of second light barriers 22 extends substantially along the first direction. The plurality of second touch signal lines 32 are arranged substantially along the second direction. Each of the plurality of second touch signal lines 32 extends substantially along the first direction. Referring to FIG. 6 and FIG. 7, at least one (e.g., each) of the plurality of first touch signal lines 31 extends through one of the plurality of the first light blocking regions B1. Optionally, at least one (e.g., each) of the plurality of first touch signal lines 31 extends through an entire length of the one of the plurality of the first light blocking regions B1. Referring to FIG. 6 and FIG. 7, the plurality of first slits 41 are spaced apart from each other and are arranged substantially along the first direction. Each of the plurality of first slits 41 extends substantially along the second direction. At least one (e.g., each) of the plurality of second touch signal lines 32 extends through one of the plurality of the second light blocking regions B2. Optionally, at least one (e.g., each) of the plurality of second touch signal lines 32 extends through an entire length of the one of the plurality of the second light blocking regions B2. Referring to FIG. 6 and FIG. 7, the plurality of second slits 42 are spaced apart from each other and are arranged substantially along the second direction. Each of the plurality of second slits 42 extends substantially along the first direction.

Referring to FIG. 6, the grating structure includes a first region R1 (the region encircled by the dotted lines) and a second region R2 outside the first region R1. The first region R1 is a region defined by the combination of the plurality of first light barriers 21 and the plurality of first slits 41. The first region R1 consists essentially of the regions corresponding to the plurality of first light barriers 21 and the plurality of first slits 41. As shown in FIG. 6, in the first region R1, a projection of at least one (e.g., each) of the plurality of first touch signal lines 31 on the transparent base substrate 10 is substantially covered by that of one of the plurality of first light barriers 21. For example, in the first region R1, the projection of at least one (e.g., each) of the plurality of first touch signal lines 31 on the transparent base substrate 10 is substantially non-overlapping with projections of the plurality of first slits 41 on the transparent base substrate 10.

Referring to FIG. 7, the grating structure includes a third region R3 (the region encircled by the dotted lines) and a fourth region R4 outside the third region R3. The third region R3 is a region defined by the combination of the plurality of second light barriers 22 and the plurality of second slits 42. The fourth region R4 consists essentially of the regions corresponding to the plurality of second light barriers 22 and the plurality of second slits 42. As shown in FIG. 7, in the third region R3, a projection of at least one (e.g., each) of the plurality of second touch signal lines 32 on the transparent base substrate 10 is substantially covered by that of one of the plurality of second light barriers 22. For example, in the third region R3, the projection of at least one (e.g., each) of the plurality of second touch signal lines 32 on the transparent base substrate 10 is substantially non-overlapping with projections of the plurality of second slits 42 on the transparent base substrate 10.

In some embodiments, the plurality of first touch signal lines 31 is electrically connected to one of the plurality of first light barriers 21. Optionally, at least one (e.g., each) of the plurality of first touch signal lines 31 is in contact with one of the plurality of first light barriers 21 over an entire length where it extends through the one of the plurality of the first light blocking regions B1. Optionally, the plurality of first touch signal lines 31 and the plurality of first light barriers 21 are in a same layer and made of a same material (e.g., formed in a single process). Optionally, a portion of at least one e.g., each) of the plurality of first touch signal lines 31 in the plurality of the first light blocking regions R1 is integrated with one of the plurality of first light barriers 21. By having the plurality of first touch signal lines 31 and the plurality of first light barriers 21 formed in a single process the fabricating process can be greatly simplified.

In some embodiments, the plurality of second touch signal lines 32 is electrically connected to one of the plurality of second light barriers 22. Optionally, at least one (e.g., each) of the plurality of second touch signal lines 32 is in contact with one of the plurality of second light barriers 22 over an entire length where it extends through the one of the plurality of the second light blocking regions B2. Optionally, the plurality of second touch signal lines 32 and the plurality of second light barriers 22 are in a same layer and made of a same material (e.g., formed in a single process). Optionally, a portion of at least one (e.g., each) of the plurality of second touch signal lines 32 in the plurality of the second light blocking regions B2 is integrated with one of the plurality of second light barriers 22. By having the plurality of second touch signal lines 32 and the plurality of second light barriers 22 thrilled in a single process, the fabricating process can be greatly simplified.

In some embodiments, in the first region R1, a projection of each of the plurality of first light barriers 21 covers those of multiple adjacent first touch signal lines of the plurality of first touch signal lines 31. As shown in FIG. 6, in the first region R1, a projection of each of the plurality of first light barriers 21 covers those of two adjacent first touch signal lines of the plurality of first touch signal lines 31. Optionally, multiple adjacent first touch signal lines of the plurality of first touch signal lines 31 extend through each of the plurality of the first light blocking regions B1, e.g., extend through an entire length of each of the plurality of the first light blocking regions B1. As shown in FIG. 6, two adjacent first touch signal lines of the plurality of first touch signal lines 31 extend through each of the plurality of the first light blocking regions B1, e.g., extend through an entire length of each of the plurality of the first light blocking regions B1. A width of each of the plurality of the first light blocking regions B1 or a width of each of each of the plurality of first light barriers 21 determines an aperture ratio of the grating structure. A density of the plurality of first touch signal lines 31 determines touch control accuracy. Accordingly, these parameters may be determined based on a desired aperture ratio or desired touch control accuracy.

In some embodiments, in the third region R3, a projection of each of the plurality of second light barriers 22 covers those of multiple adjacent second touch signal lines of the plurality of second touch signal lines 32. As shown in FIG. 6 and FIG. 7, in the third region R3, a projection of each of the plurality of second light barriers 22 covers those of two adjacent second touch signal lines of the plurality of second touch signal lines 32. Optionally, multiple adjacent second touch signal lines of the plurality of second touch signal lines 32 extend through each of the plurality of the second light blocking regions B2, e.g., extend through an entire length of each of the plurality of the second light blocking regions B2. As shown in FIG. 6 and FIG. 7, two adjacent second touch signal lines of the plurality of second touch signal lines 32 extend through each of the plurality of the second light blocking regions B2, e.g., extend through an entire length of each of the plurality of the second light blocking regions B2. A width of each of the plurality of the second light blocking regions B2 or a width of each of each of the plurality of second light barriers 22 determines an aperture ratio of the grating structure. A density of the plurality of second touch signal lines 32 determines touch control accuracy. Accordingly, these parameters may be determined based on a desired aperture ratio or desired touch control accuracy.

By having each of the plurality of first touch signal lines 31 extending through one of the plurality of the first light blocking regions B1, the presence of the plurality of first touch signal lines 31 in the grating structure do not interfere with light transmission through the first grating layer in the plurality of first slits 41. By having each of the plurality of second touch signal lines 32 extending through one of the plurality of the second light blocking regions B2, the presence of the plurality of second touch signal lines 32 in the grating structure do not interfere with light transmission through the second grating layer in the plurality of second slits 42.

In some embodiments, the plurality of first light barriers 21 and the plurality of second light barriers 22 are made of a black ink including a conductive material, and the plurality of first touch signal lines 31 and the plurality of second touch signal lines 32 are made of a same conductive material. Various appropriate conductive material may be used for making the plurality of first light barriers 21, the plurality of second light barriers 22, the plurality of first touch signal lines 31, and the plurality of second touch signal lines 32. Examples of conductive materials include nano-metal particles (e.g., nano-silver particles), carbon particle materials, nano-tubes, graphene, and so on. Optionally, the plurality of first touch signal lines 31 and the plurality of second touch signal lines 32 are made of nano-silver particles, and the plurality of first light barriers 21 and the plurality of second light barriers 22 are made of a black nano-silver particle ink. Accordingly, the plurality of first light barriers 21 and the plurality of first touch signal lines 31 can be made in a single process, and the plurality of second light barriers 22 and the plurality of second touch signal lines 32 can be made in a single process. A portion of at least one (e.g., each) of the plurality of first touch signal lines 31 in the plurality of the first light blocking regions B1 is integrated with one of the plurality of first light barriers 21. For example, the portion of at least one (e.g., each) of the plurality of first touch signal lines 31 in the first region R1 is integrated with one of the plurality of first light barriers 21. A portion of at least one (e.g., each) of the plurality of second touch signal lines 32 in the plurality of the second light blocking regions B2 is integrated with one of the plurality of second light barriers 22. For example, the portion of at least one (e.g., each) of the plurality of second touch signal lines 32 in the third region R3 is integrated with one of the plurality of second light barriers 22.

Various appropriate transparent materials may be used for making the transparent base substrate 10. Optionally, the transparent base substrate 10 is made of polyethylene glycol terephthalate, or polyethylene naphthalate, or a combination thereof.

In some embodiments, the grating structure further includes an insulating layer between the first grating layer and the second grating layer, and between the first touch signal line layer and the second touch signal line layer.

Referring to FIG. 6 and FIG. 7, at least one (e.g., each) of the plurality of first touch signal lines 31 in some embodiments includes a portion outside the plurality of the first light blocking regions B1 or outside the first region R1 (e.g., in the second region R2), and at least one (e.g., each) of the plurality of second touch signal lines 32 in some embodiments includes a portion outside the plurality of the second light blocking regions B2 or outside the third region R3 (e.g., in the fourth region R4). In FIG. 6, the touch sensing area is greater than the grating area (e.g., an area in a combination of the first region R1 and the third region R3).

Optionally, the first touch signal line layer in some embodiments further includes a plurality of first connecting wires 51 electrically connecting the plurality of first touch signal lines 31 to the touch driver circuit in the touch driver chip 100. Optionally, the second touch signal line layer in some embodiments further includes a plurality of second connecting wires 52 electrically connecting the plurality of second touch signal lines 32 to the touch driver circuit in the touch driver chip 100. The plurality of first connecting wires 51 are disposed outside the plurality of the first light blocking regions B1 or outside the first region R1 (e.g., in the second region R2). The plurality of second connecting wires 52 are disposed outside the plurality of the second light blocking regions B2 or outside the third region R3 (e.g., in the fourth region R4).

As shown in FIG. 6, in a display apparatus having the present grating structure the plurality of first touch signal lines 31 and the plurality of second touch signal lines 32 are respectively connected to a touch driver circuit in a touch driver chip 100, which is disposed in a printed circuit board 200 and electrically connected to a display circuit board 400 through a connector 300. The display circuit board 400 is electrically connected to a mother board 500 of the display apparatus. In a display apparatus having the present grating structure, the mother board 500 sends control signals to control the touch driver circuit in the touch driver chip 100 to send touch control signals or receive touch sensing signals. Optionally, the display apparatus further includes a display panel, and the grating structure is on a light emitting side of the display panel.

In another aspect, the present disclosure provides a method of fabricating a grating structure. In some embodiments, the method includes forming a first grating layer on a transparent base substrate; and forming a first touch signal line layer on the transparent base substrate. Optionally, the step of forming the first grating layer includes forming a plurality of first light barriers in a plurality of first light blocking regions using an electrically conductive material. The plurality of first light barriers are formed to be arranged substantially along a first direction. Each of the plurality of first light barriers is formed to extend substantially along a second direction. Optionally, the step of forming the first touch signal line layer includes forming a plurality of first touch signal lines arranged substantially along the first direction. Each of the plurality of first touch signal lines is formed to extend substantially along the second direction and extend through one of the plurality of the first light blocking regions.

In some embodiments, the first grating layer and the first touch signal line layer are formed so that at least one (e.g., each) of the plurality of first touch signal lines is electrically connected to one of the plurality of first light barriers. Optionally, the first grating layer and the first touch signal line layer are formed so that at least one (e.g., each) of the plurality of first touch signal lines is in contact with one of the plurality of first light barriers over an entire length wherein it extends through the one of the plurality of the first light blocking regions. Optionally, the first grating layer and the first touch signal line layer are formed in a same layer, in a single patterning process (e.g., with a single mask plate), and using a same material; and the first grating layer and the first touch signal line layer are formed so that a portion of at least one (e.g., each) of the plurality of first touch signal lines in the plurality of the first light blocking regions is integrated with one of the plurality of first light barriers.

In some embodiments, the method further includes forming a second touch signal line layer on the transparent base substrate. Optionally, the step of forming the second touch signal line layer includes forming a plurality of second touch signal lines. Optionally, the method further includes forming an insulating layer between the second touch signal line layer and the first grating layer. Optionally, the plurality of second touch signal lines are formed to be arranged substantially along the second direction. Optionally, each of the plurality of second touch signal lines is formed to extend substantially along the first direction. Optionally, the insulating layer is formed on a side of the second grating layer distal to the transparent base substrate; and the first grating layer and the first touch signal line layer are formed on a side of the insulating layer distal to the second grating layer.

In some embodiments, the method further includes forming a second grating layer on the transparent base substrate. Optionally, the step of forming the second grating layer includes forming a plurality of second light barriers in a plurality of second light blocking regions of the grating structure. Optionally, the plurality of second light barriers are formed to be spaced apart from each other by a plurality of second light transmissive regions. Optionally, the plurality of second light barriers are framed using an electrically conductive material. Optionally, at least one (e.g., each) of the plurality of second touch signal lines is formed to extend through one of the plurality of the second light blocking regions, e.g., through an entire length of the one of the plurality of the second light blocking regions.

In some embodiments, the second grating layer and the second touch signal line layer are formed so that at least one (e.g., each) of the plurality of second touch signal lines is electrically connected to one of the plurality of second light barriers. Optionally, the second grating layer and the second touch signal line layer are formed so that at least one (e.g., each) of the plurality of second touch signal lines is in contact with one of the plurality of second light barriers over an entire length wherein it extends through the one of the plurality of the second light blocking regions. Optionally, the second grating layer and the second touch signal line layer are formed in a same layer, in a single patterning process (e.g., with a single mask plate), and using a same material; and the second grating layer and the second touch signal line layer are formed so that a portion of at least one (e.g., each) of the plurality of second touch signal lines in the plurality of the second light blocking regions is integrated with one of the plurality of second light barriers.

In some embodiments, the first touch signal line layer is formed so that at least one (e.g., each) of the plurality of first touch signal lines includes a portion outside the plurality of the first light blocking regions. Optionally, the step of forming the first touch signal line layer further includes forming a plurality of first connecting wires electrically connecting the plurality of first touch signal lines to a touch driver circuit. Optionally, the plurality of first connecting wires are formed outside the plurality of first light blocking regions.

In some embodiments, the second touch signal line layer is formed so that at least one (e.g., each) of the plurality of second touch signal lines includes a portion outside the plurality of the second light blocking regions. Optionally, the step of forming the second touch signal line layer further includes forming a plurality of connecting wires electrically connecting the plurality of second touch signal lines to a touch driver circuit. Optionally, the plurality of second connecting wires are formed outside the plurality of second light blocking regions.

Optionally, the plurality of first light barriers are formed using a black ink including a conductive material. Optionally, the plurality of first touch signal lines are formed using a same conductive material. Optionally, the plurality of first light barriers are formed using a black nano-silver particle ink, and the plurality of first touch signal lines are formed using nano-silver particles.

Optionally, the plurality of second light barriers are formed using a black ink including a conductive material. Optionally, the plurality of second touch signal lines are formed using a same conductive material. Optionally, the plurality of second light barriers are formed using a black nano-silver particle ink, and the plurality of second touch signal lines are formed using nano-silver particles.

Optionally, the transparent base substrate is formed using polyethylene glycol terephthalate, or polyethylene naphthalate, or a combination thereof.

FIG. 8 is a flow chart illustrating a method of fabricating a grating structure in some embodiments according to the present disclosure. Referring to FIG. 8, the method in some embodiments includes forming a polymer layer on the transparent base substrate; forming an activated surface pattern on the polymer layer corresponding to a pattern of the first grating layer and the first touch signal line layer; and coating a black ink having a conductive material on the polymer layer, thereby forming the first grating layer and the first touch signal line layer. Optionally, the step of forming the activated surface pattern includes exposing the polymer layer to UV irradiation using a mask plate having a pattern corresponding to the pattern of the first grating layer and the first touch signal line layer. Exposed portions of the polymer layer are activated thereby forming an activated surface pattern for adhering the black ink having the conductive material.

In one example, the black ink having the conductive material is blade-coated on the polymer layer having the activated surface pattern. The black ink adheres only to the exposed portions having the activated surface pattern, but not the remainder of the polymer layer. Optionally, the method further includes drying the black ink adhered to the activated surface pattern, thereby forming the first grating layer and the first touch signal line layer.

In one example, the polymer layer includes a fluoropolymer.

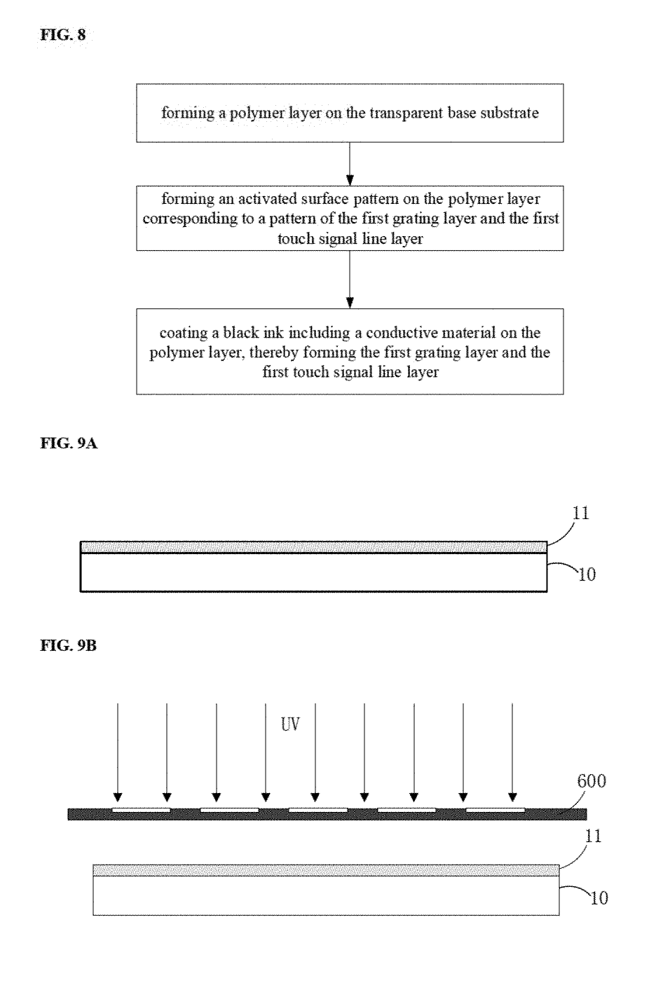

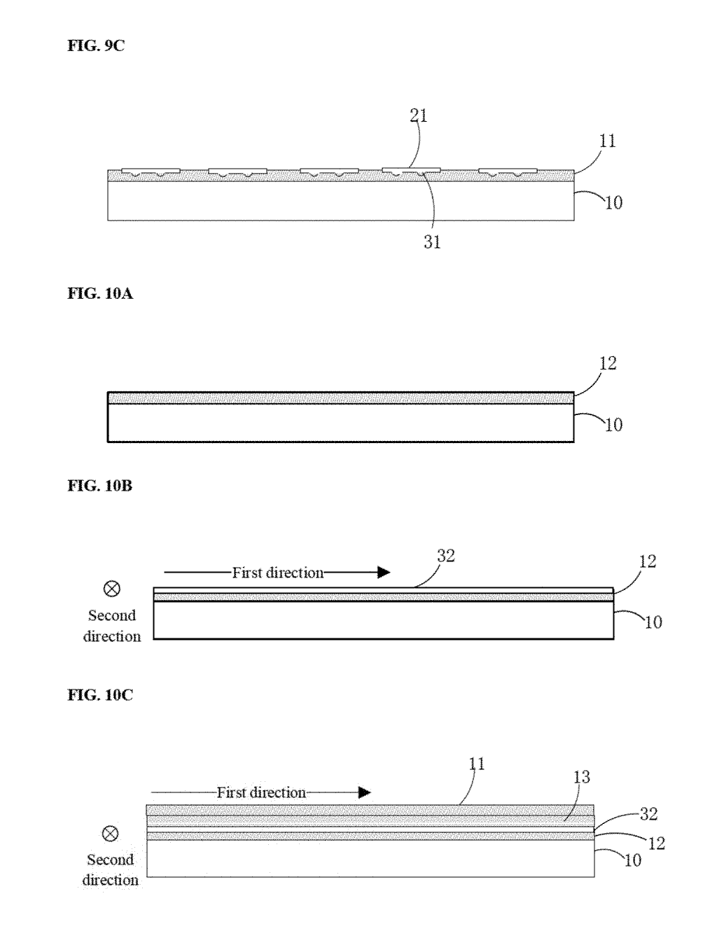

FIGS. 9A to 9C illustrate a process of fabricating a grating structure in some embodiments according to the present disclosure. Referring to FIG. 9A, a polymer layer 11, e.g., a fluoropolymer layer, is first formed on the transparent base substrate 10. Referring to FIG. 9B, the polymer layer 11 is exposed to UV irradiation using a mask plate 600 having a pattern corresponding to the pattern of the first grating layer and the first touch signal line layer. Subsequent to exposure to UV irradiation, a black ink having a conductive material is then coated on the polymer layer 11. Referring to FIG. 9C, the black ink adheres to exposed portion of the polymer layer 11 having an activated surface pattern corresponding to the pattern of the first grating layer and the first touch signal line layer. After the black ink is dried, a first grating layer having a plurality of first light barriers 21 and a first touch signal line layer having a plurality of first touch signal lines 31 are formed on the transparent base substrate 10.

In a grating structure fabricating by the present method, as illustrated in FIGS. 9A to 9C, at least a portion of at least one (e.g., each) of the plurality of first touch signal lines in the plurality of the first light blocking regions is integrated with one of the plurality of first light barriers. At least one (e.g., each) of the plurality of first touch signal lines 31 extends through one of the plurality of the first light blocking regions. Thus, the presence of the plurality of first touch signal lines 31 in the grating structure do not interfere with light transmission through the first grating layer in the plurality of first slits. Moreover, because the first grating layer and the first touch signal line layer are formed in a single process, the fabricating process of the grating structure is greatly simplified.

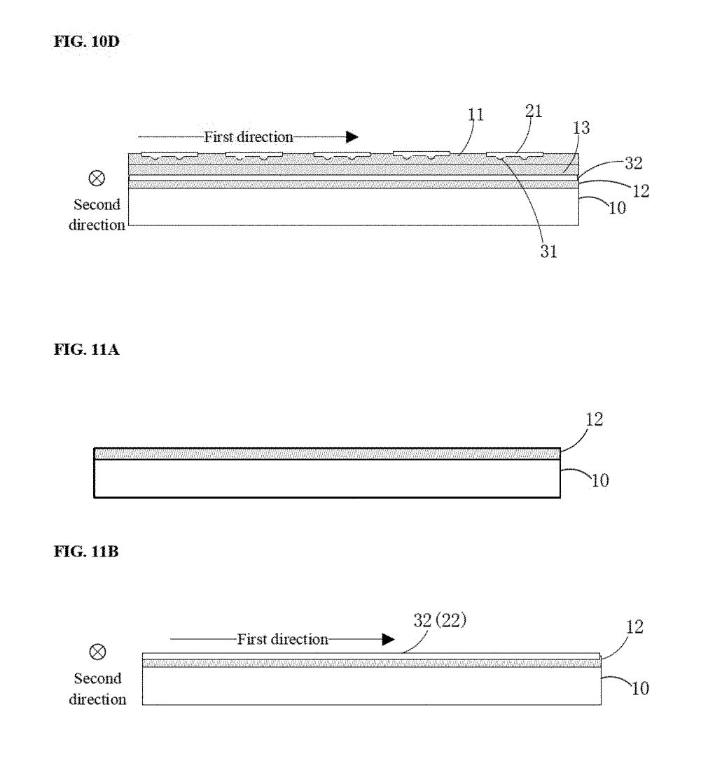

FIGS. 10A to 10D illustrate a process of fabricating a grating structure in some embodiments according to the present disclosure. Referring to FIG. 10A, a polymer layer 12, e.g., a fluoropolymer layer, is first formed on the transparent base substrate 10. The polymer layer 12 is exposed to UV irradiation using a mask plate having a pattern corresponding to the pattern of a second touch signal line layer. Subsequent to exposure to UV irradiation, a black ink having a conductive material is then coated on the polymer layer 12. Referring to FIG. 10B, the black ink adheres to exposed portion of the polymer layer 12 having an activated surface pattern corresponding to the pattern of the second touch signal line layer. After the black ink is dried, a second touch signal line layer having a plurality of second touch signal lines 32 are formed on the transparent base substrate 10. Each of the plurality of second touch signal lines 32 extends substantially along a first direction.

Referring to FIG. 10C, subsequent to forming the second touch signal line layer, an insulating layer 13 is then formed on the transparent base substrate 10. The insulating layer 13 may be formed using an optical clear resin material. A polymer layer 11, e.g., a fluoropolymer layer, is formed on a side of the insulating layer 13 distal to the transparent base substrate 10. Subsequently, the polymer layer 11 is exposed to UV irradiation using a mask plate having a pattern corresponding to the pattern of the first grating layer and the first touch signal line layer. Subsequent to exposure to UV irradiation, a black ink having a conductive material is then coated on the polymer layer 11. Referring to FIG. 10D, the black ink adheres to exposed portion of the polymer layer 11 having an activated surface pattern corresponding to the pattern of the first grating layer and the first touch signal line layer. After the black ink is dried, a first grating layer having a plurality of first light barriers 21 and a first touch signal line layer having a plurality of first touch signal lines 31 are formed on the transparent base substrate 10. Each of the plurality of first touch signal lines 31 extends substantially along a second direction. Optionally, the first direction is substantially perpendicular to the second direction.

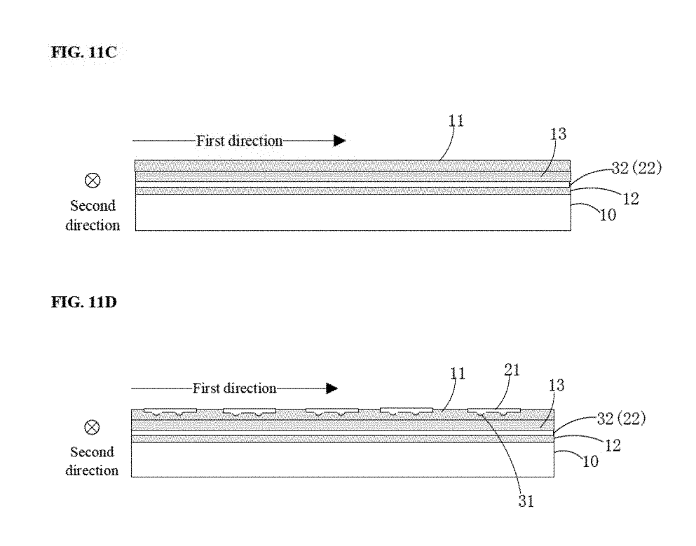

FIGS. 11A to 11D illustrate a process of fabricating a grating structure in some embodiments according to the present disclosure. Referring to FIG. 11A, a polymer layer 12, e.g., a fluoropolymer layer, is first formed on the transparent base substrate 10. The polymer layer 12 is exposed to UV irradiation using a mask plate having a pattern corresponding to the pattern of a second touch signal line layer and a second grating layer. Subsequent to exposure to UV irradiation, a black ink having a conductive material is then coated on the polymer layer 12. Referring to FIG. 11B, the black ink adheres to exposed portion of the polymer layer 12 having an activated surface pattern corresponding to the pattern of the second touch signal line layer and the second grating layer. After the black ink is dried, a second touch signal line layer having a plurality of second touch signal lines 32 and a second grating layer having a plurality of second light barriers 22 are formed on the transparent base substrate 10. Each of the plurality of second touch signal lines 32 extends substantially along a first direction.

Referring to FIG. 11C, subsequent to forming the second touch signal line layer and the second grating layer, an insulating layer 13 is then formed on the transparent base substrate 10. The insulating layer 13 maybe formed using an optical clear resin material. A polymer layer 11, e.g., a fluoropolymer layer, is formed on a side of the insulating layer 13 distal to the transparent base substrate 10. Subsequently, the polymer layer 11 is exposed to UV irradiation using a mask plate having a pattern corresponding to the pattern of the first grating layer and the first touch signal line layer. Subsequent to exposure to UV irradiation, a black ink having a conductive material is then coated on the polymer layer 11. Referring to FIG. 10D, the black ink adheres to exposed portion of the polymer layer 11 having an activated surface pattern corresponding to the pattern of the first grating layer and the first touch signal line layer. After the black ink is dried, a first grating layer having a plurality of first light barriers 21 and a first touch signal line layer having a plurality of first touch signal lines 31 are formed on the transparent base substrate 10. Each of the plurality of first touch signal lines 31 extends substantially along a second direction. Optionally, the first direction is substantially perpendicular to the second direction.

In another aspect, the present disclosure provides a display apparatus having a grating structure described herein or fabricated by a method described herein. In some embodiment, the display apparatus further includes a display panel and a touch control circuit electrically connected to a plurality of first touch signal lines. The grating structure is on a light emitting side of the display panel. Optionally, the touch control circuit is electrically connected to a plurality of first touch signal lines and a plurality of second touch signal lines. Optionally, the touch control circuit is integrated into a display control circuit of the display apparatus.

In the present display apparatus, the grating structure may be attached to the display panel by an optical clear liquid adhesive or an optical clear adhesive film. Optionally, the display apparatus is a multi-view display apparatus. Optionally, the display apparatus is a three-dimensional display apparatus. Examples of appropriate display apparatuses includes, but are not limited to, an electronic paper, a mobile phone, a tablet computer, a television, a monitor, a notebook computer, a digital album, a GPS, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may he made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A grating structure, comprising:
a transparent base substrate;
a first grating layer on the transparent base substrate and configured to direct light transmitted through a grating structure into a first view zone and a second view zone; and
a first touch signal line layer on the transparent base substrate and comprising a plurality of first touch signal lines;
wherein the first grating layer comprises a plurality of first light barriers respectively in a plurality of first light blocking regions and a plurality of first slits respectively in a plurality of first light transmissive regions;
the plurality of first light barriers are substantially along a first direction, each of the plurality of first light barriers extending substantially along a second direction;
the plurality of first slits are substantially along the first direction, each of the plurality of first slits extending substantially along the second direction;
the plurality of first touch signal lines are substantially along the first direction, each of the plurality of first touch signal lines extending substantially along the second direction; and
at least one of the plurality of first touch signal lines extends through one of the plurality of the first light blocking regions.

2. The grating structure of claim 1, wherein at least one of the plurality of first touch signal lines is electrically connected to one of the plurality of first light barriers.

3. The grating structure of claim 2, wherein at least one of the plurality of first touch signal lines is in contact with one of the plurality of first light barriers over an entire length where it extends through the one of the plurality of the first light blocking regions.

4. The grating structure of claim 1, wherein the first grating layer and the first touch signal line layer are in a same layer and comprise a same material; and
at least a portion of each of the plurality of first touch signal lines in the plurality of the first light blocking regions is integrated with one of the plurality of first light barriers.

5. The grating structure of claim 1, further comprising:
a second touch signal line layer on the transparent base substrate and comprising a plurality of second touch signal lines; and
an insulating layer between the second touch signal line layer and the first grating layer;
wherein the plurality of second touch signal lines are substantially along the second direction, each of the plurality of second touch signal lines extending substantially along the first direction.

6. The grating structure of claim 5, further comprising:
a second grating layer on the transparent base substrate and comprising a plurality of second light barriers respectively in a plurality of second light blocking regions and a plurality of second slits respectively in a plurality of second light transmissive regions; and
at least one of the plurality of second touch signal lines extends through one of the plurality of the second light blocking regions.

7. The grating structure of claim 6, wherein the insulating layer is on a side of the second grating layer distal to the transparent base substrate; and
the first grating layer and the first touch signal line layer are on a side of the insulating layer distal to the second grating layer.

8. The grating structure of claim 6, wherein at least one of the plurality of second touch signal lines is electrically connected to one of the plurality of second light barriers.

9. The grating structure of claim 7, wherein at least one of the plurality of second touch signal lines is in contact with one of the plurality of second light barriers over an entire length where it extends through the one of the plurality of the second light blocking regions.

10. The grating structure of claim 6, wherein the second grating layer and the second touch signal line layer are in a same layer and comprise a same material; and
at least a portion of each of the plurality of second touch signal lines in the plurality of the second light blocking regions is integrated with one of the plurality of second light barriers.

11. The grating structure of claim 1, wherein at least one of the plurality of first touch signal lines comprises a portion outside the plurality of the first light blocking regions.

12. The grating structure of claim 1, wherein the first touch signal line layer further comprising a plurality of connecting wires electrically connecting the plurality of first touch signal lines to a touch driver circuit;
wherein the plurality of connecting wires are outside the plurality of first light blocking regions.

13. The grating structure of claim 1, wherein the plurality of first light barriers comprise a black ink comprising a conductive material; and
the plurality of first touch signal lines comprise the conductive material.

14. The grating structure of claim 13, wherein the plurality of first light barriers comprise a black nano-silver particle ink; and
the plurality of first touch signal lines comprise nano-silver particles.

15. The grating structure of claim 1, wherein the transparent base substrate comprises polyethylene glycol terephthalate, or polyethylene naphthalate, or a combination thereof.

16. A display apparatus, comprising the grating structure of claim 1;
a display panel; and
a touch control circuit electrically connected to the plurality of first touch signal lines;
wherein the grating structure is on a light emitting side of the display panel.

17. A method of fabricating a grating structure, comprising:
forming a first grating layer on a transparent base substrate; and
forming a first touch signal line layer on the transparent base substrate;
wherein forming the first grating layer comprises forming a plurality of first light barriers in a plurality of first light blocking regions; the plurality of first light barriers being formed to be arranged substantially along a first direction, each of the plurality of first light barriers being formed to extend substantially along a second direction; and
forming the first touch signal line layer comprises forming a plurality of first touch signal lines arranged substantially along the first direction, each of the plurality of first touch signal lines being formed to extend substantially along the second direction and extend through one of the plurality of the first light blocking regions.

18. The method of claim 17, wherein the first grating layer and the first touch signal line layer are formed in a single process using a same material.

19. The method of claim 17, comprising:
forming a polymer layer on the transparent base substrate;
forming an activated surface pattern on the polymer layer corresponding to a pattern of the first grating layer and the first touch signal line layer; and
coating a black ink comprising a conductive material on the polymer layer, thereby forming the first grating layer and the first touch signal line layer.

20. The method of claim 19, wherein the polymer layer comprises a fluoropolymer;
forming the activated surface pattern comprises exposing the polymer layer to UV irradiation using a mask plate having a pattern corresponding to the pattern of the first grating layer and the first touch signal line layer; and
exposed portions of the polymer layer are activated for adhering the black ink comprising the conductive material.
